(19) United States
(12) Patent Application Publication
(10) Pub. No.: US 2022/0163730 A1
(43) Pub. Date: May 26, 2022

(54) FIBER PROTECTION SYSTEM FOR A FIBER OPTIC CONNECTOR

(71) Applicant: COMMSCOPE TECHNOLOGIES LLC, Hickory, NC (US)

(72) Inventors: Danny Willy August VERHEYDEN, Gelrode (BE); David TIMMERMANS, Kessel-Lo (BE); Peter STOCKMANS, Aarschot (BE); Heidi KEMPS, Scherpenheuvel (BE); Ann VANDERSTUKKEN, Gelrode (BE)

(73) Assignee: COMMSCOPE TECHNOLOGIES LLC, Hickory, NC (US)

(21) Appl. No.: 17/602,638

(22) PCT Filed: Apr. 8, 2020
(86) PCT No.: PCT/US2020/027295

§ 371 Date: Oct. 8, 2021

Related U.S. Application Data
(60) Provisional application No. 62/830,960, filed on Apr. 8, 2019.

(51) Int. Cl. G02B 6/38

(52) U.S. Cl. CPC G02B 6/3809

(57) ABSTRACT

The present disclosure relates to fiber optic connectors having integrated features for protecting the optical fibers of the fiber optic connectors. The fiber optic connectors can include protective features such as retractable noses and shutters,

### CROSS-REFERENCE TO RELATED APPLICATION

This application is being filed on Apr. 8, 2020 as a PCT International

Patent Application and claims the benefit of U.S. Patent Application Ser. No. 62/830,960, filed on Apr. 8, 2019, the disclosure of which is incorporated herein by reference in its entirety.

### TECHNICAL FIELD

The present disclosure relates generally to fiber optic connection components such as fiber optic connectors and adapters. More particularly, the present disclosure relates to ferrule-less fiber optic connection components, systems and methods.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles (LC, SC, MPO), alignment between two fiber optic connectors is provided through the use of an intermediate fiber optic adapter.

Another type of fiber optic connector can be referred to as a ferrule-less fiber optic connector. In a ferrule-less fiber optic connector, an end portion of an optical fiber corresponding to the ferrule-less fiber optic connector is not supported by a ferrule. Instead, the end portion of the optical fiber is a free end portion. Similar to the ferruled connectors described above, fiber optic adapters can be used to assist in optically coupling together two ferrule-less fiber optic connectors. Example ferrule-less fiber optic connectors and/or fiber optic adapters are disclosed by PCT Publication Nos. WO 2012/112344; WO 2013/117598; WO 2017/081306; WO 2016/100384; WO 2016/043922; and U.S. Pat. Nos. 8,870,466 and 9,575,272.

Fiber optical adapters are used to optically couple together optical fiber tips of optical connectors. To accommodate ferrule-less fiber optic connectors, fiber optical adapters can include specialized fiber alignment devices to receive bare optical fibers and align the fiber tips of the connectors received therein to enable the transfer of optical signals therebetween. Optical connectors can be secured to the optical adapters when received at the ports of the optical adapters. Ferrule-less optical connectors can include integrated features for protecting the optical fibers when the fiber optic connectors are not installed within fiber optic adapters. Example ferrule-less fiber optic connectors having integrated optical fiber protecting features are disclosed by PCT International Publication Numbers WO 2016/100384; WO 2017/070220; and WO 2017/081306.

### SUMMARY

Aspects of the present disclosure relates to systems for protecting optical fibers of fiber optic connectors. The systems can include fiber protecting features that are integrated at the front end of a fiber optic connector. The various aspects of the present disclosure are applicable to single-fiber and multi-fiber optical connectors. The optical connectors can include ferrule-less optical connectors each having at least one optical fiber with a non-ferrulized end portion. In certain examples, the protective features can include structures such as retractable noses and moveable shutters.

Another aspect of the present disclosure relates to a fiber optic connector having a shutter for protecting an optical fiber of the fiber optic connector. The shutter is configured to flex between an open shutter position and a closed shutter position. The fiber optic connector can include a guide which engages at least a portion of the shutter slide to control flexion of the shutter between the open and closed shutter positions. In one example, the guide can include channels that receive opposite side portions of the shutter. In certain examples, the guides can be incorporated within a nose piece that also provides fiber protection. In certain examples, the nose piece can be retractable. In certain examples, the shutter has a molded, plastic construction. In certain examples, the shutter flexes between the open and closed shutter positions as the shutter is moved axially relative to a portion of the fiber optic connectors at which curvature guides are integrated (e.g., a nose piece).

In certain examples, the shutter is molded with an elongate linear portion unitarily formed with a curved shutter portion, and the shutter portion is configured to flex relative to the elongate linear portion between the open and closed shutter positions. In certain examples, the shutter is a molded plastic part which is molded with a curvature corresponding to the closed shutter position. In certain examples, the shutter has a curvature that straightens as the shutter is moved from the closed shutter position toward the open shutter position, and that increases in curvature as the shutter moves from the open shutter position toward the closed shutter position. In certain examples, the shutter has a plastic construction, and a guide structure for controlling flexion of the shutter assures that the shutter reliably moves between the open and closed positions. In certain examples, the shutter can be molded with a pre-formed curvature that facilitates assembling the shutter within the fiber optic connector.

Another aspect of the present disclosure relates to a fiber optic connector having a housing assembly through which an optical fiber is routed. The housing assembly includes a fiber protection structure integrated with the fiber optic connector adjacent a front end of the housing assembly. The fiber protection structure is movable between a first position where the optical fiber is protected within the housing assembly and a second position in which the optical fiber is presented for connection to the other optical fiber. For example, in the second position the optical fiber can project forwardly from a front surface of the fiber protection structure. The fiber optic connector can also include a locking member hidden within the connector housing arrangement for locking the fiber protection structure in the first position. The locking member is movable between a locking position in which the locking member retains the fiber protection structure in the first position and a release position in which the fiber protection structure can move from the first position toward the second position. The hidden nature of the locking member also discourages tampering with the locking member. In certain examples, the locking member can have a metal construction. For example, the locking member can include a metal leaf spring. In certain examples, a secondary member defined by the housing arrangement can be used to move the locking member from the locking position to the release position. In one particular example, the housing arrangement can include a nose piece having a cantilever structure that conceals the locking member and that can be flexed to move the locking member from the locking position to the release position.

Another aspect of the present disclosure relates to a fiber optic connector including a connector body having a front end and a rear end. The connector body defines a connector axis that extends between the front and rear ends. The fiber optic connector also includes an optical fiber routed through the connector body along the connector axis.

The optical fiber has a non-ferrulized front end portion. The fiber optic connector also includes a fiber protection arrangement positioned at the front end of the connector body. The fiber protection arrangement includes a nose piece and a shutter piece. The nose piece includes a front surface through which a front fiber opening is defined. The nose piece is movable along the connector axis relative to the connector body and the optical fiber between a forward nose position and a rearward nose position. The non-ferrulized front end portion of the optical fiber is recessed with respect to the front surface of the nose piece when the nose piece is in the forward position. The optical fiber extends through the fiber opening with the non-ferrulized front end of the optical fiber projecting forwardly beyond the front surface of the nose piece when the nose piece is in the rearward nose position. The shutter piece includes a front shutter portion and an elongate rear portion. The front shutter portion is adapted to flex relative to the rear portion between a closed shutter position in which the shutter portion blocks the fiber opening and an open shutter position in which the shutter portion does not interfere with passage of the optical fiber through the fiber opening. The fiber optic connector also includes a mechanical interface defined between the shutter piece and the nose piece for controlling flexion of the front shutter portion of the shutter piece. The front shutter portion is actuated between the closed and open shutter positions by generating relative movement between the nose piece and the shutter piece in an orientation along the connector axis. The mechanical interface controls flexion of the front shutter portion from the closed shutter position to the open shutter position when the shutter piece is moved rearwardly along the connector axis relative to the nose piece. The mechanical interface controls flexion of the front shutter portion from the open shutter position to the closed shutter position when the shutter piece is moved forwardly relative to the nose piece along the connector axis.

Another aspect of the present disclosure relates to a fiber protection arrangement for a fiber optic connector. The fiber protection arrangement includes a nose piece movable along a connector axis between a first nose position in which an end of an optical fiber of the fiber optic connector is protected by the nose piece and a second nose position in which the end of the optical fiber is presented for connection to an optical fiber of another fiber optic connector. The fiber protection arrangement also includes a shutter that flexes between a first shutter position in which the shutter is intersected by an axis of the optical fiber and a second shutter position in which the shutter is not intersected by the axis of the optical fiber. The fiber protection arrangement further includes a mechanical interface defined between the shutter and the nose piece for controlling flexion of the shutter. The shutter is actuated between the first and second shutter positions by generating relative movement between the nose piece and the shutter in an orientation along the connector axis. The mechanical interface controls flexion of the shutter from the first shutter position to the second shutter position when relative movement is generated between the nose piece and the shutter in a first direction along the connector axis. The mechanical interface controls flexion of the shutter from the second shutter position to the first shutter position when relative movement is generated between the nose piece and the shutter in a second direction along the connector axis. The second direction is opposite from the first direction.

A further aspect of the present disclosure relates to a connector including a connector housing arrangement which includes a connector body and nose piece. The connector body has a front end and a rear end. The connector body defines a connector axis that extends between the front and rear ends. The fiber optic connector also includes an optical fiber routed through the connector body along the connector axis. The optical fiber has a non-ferrulized front end portion. The fiber optic connector further includes a nose piece including a front surface through which a fiber opening is defined. The nose piece is movable along the connector axis relative to the connector body and the optical fiber between a forward nose position and a rearward nose position. A non-ferrulized front end portion of the optical fiber is recessed with respect to a front surface of the nose piece when the nose piece is in the forward nose position. The optical fiber extends through the fiber opening with the non-ferrulized front end portion of the optical fiber projecting forwardly beyond the front surface of the nose piece when the nose piece is in the rearward nose position. The fiber optic connector further includes a nose piece lock including a locking member hidden within the connector housing arrangement for locking the nose piece in the forward nose position. The locking member is movable between a locking position in which the locking member retains the nose piece in the forward nose position and release position in which the nose piece can move from the forward nose position to the rearward nose position.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view showing a fiber optic connector in accordance with the principles of the present disclosure having a front fiber protection arrangement depicted in a fiber protecting configuration;

FIG. 2 is a perspective view of the fiber optic connector of FIG. 1 with the fiber protection arrangement depicted in a fiber access configuration;

FIG. 3 is a cross-sectional view taken along section line 3-3 of FIG. 1;

FIG. 4 is a cross-sectional view taken along section line 4-4 of FIG. 2;

FIG. 5 is a cross-sectional view taken along section line 5-5 of FIG. 1;

FIG. 6 is a cross-sectional view of the fiber optic connector of FIG. 1 showing an internal shutter of the fiber protection arrangement in an open position;

FIG. 7 is a cross-sectional view of the fiber optic connector of FIG. 1 depicting a guide portion of the internal shutter positioned within a guide channel; the cross-section has been taken while the internal shutter is in the open position;

FIG. 8 is a front, bottom perspective view of the fiber optic connector of FIG. 1;

FIG. 9 is a cross-sectional view showing the fiber optic connector of FIG. 1 with the fiber protection arrangement in the fiber protecting configuration and with a nose piece of the fiber protection arrangement locked in a forward position by a locking member;

FIG. 10 is a cross-sectional view of the fiber optic connector of FIG. 1 with the nose piece locked in the forward position and with the internal shutter of the fiber protection arrangement in an open position;

FIG. 11 is a cross-sectional view showing the fiber optic connector of FIG. 1 with the fiber protection arrangement in the fiber access position in which the internal shutter is in the open position and both the nose piece and the internal shutter are in rearward positions;

FIG. 12 is a cross-sectional view showing two of the fiber optic connectors of FIG. 1 optically coupled together by a fiber optic adapter;

FIG. 13 is an enlarged view of a front portion of FIG. 4;

FIG. 14 is an enlarged view of a front portion of FIG. 3; and

FIG. 15 is a cross-sectional view taken along section line 15-15 of FIG. 13.

### DETAILED DESCRIPTION

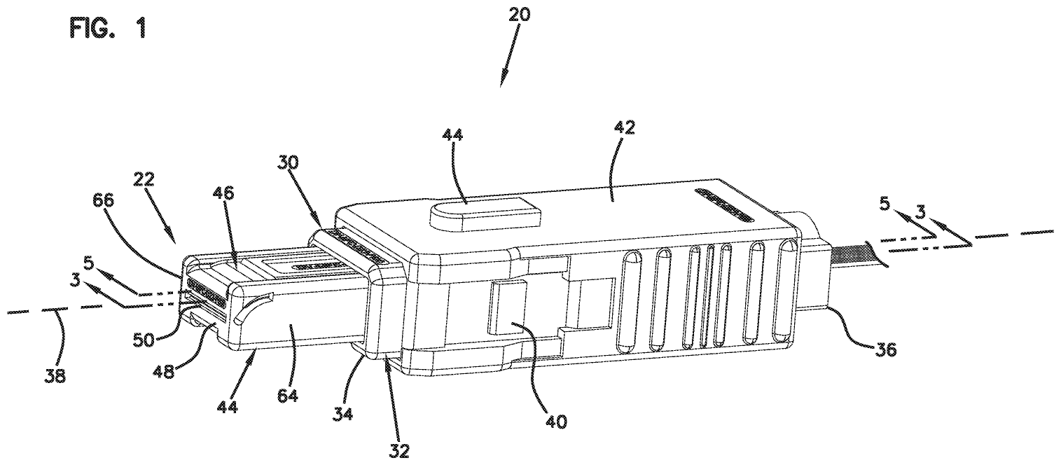

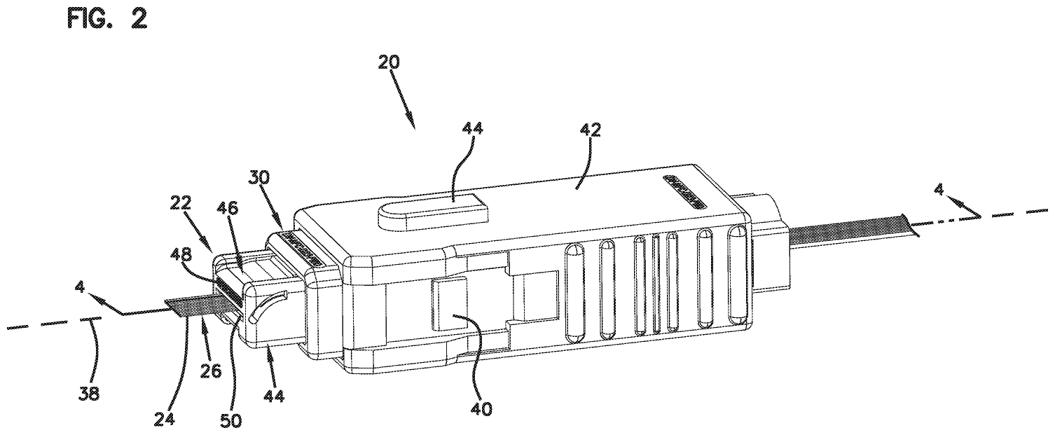

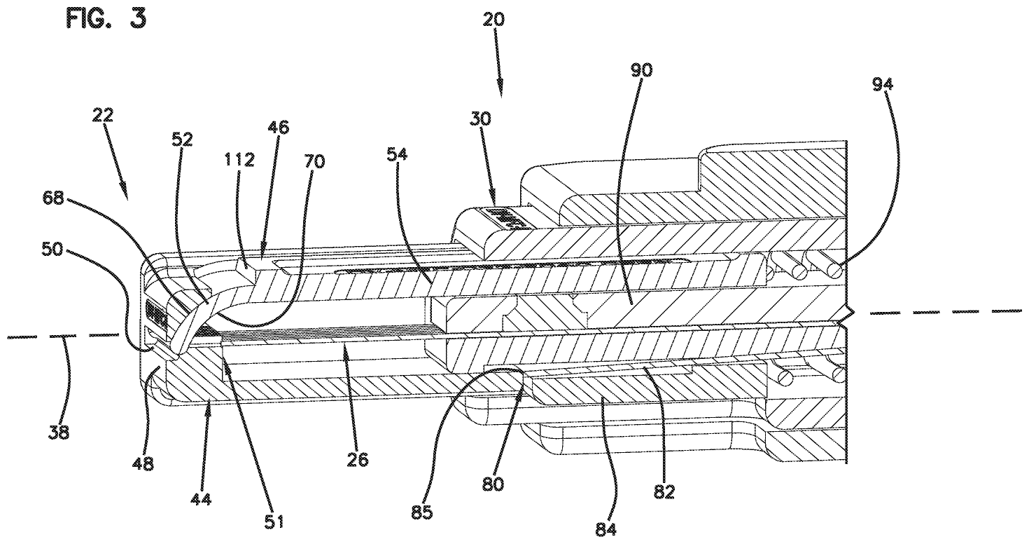

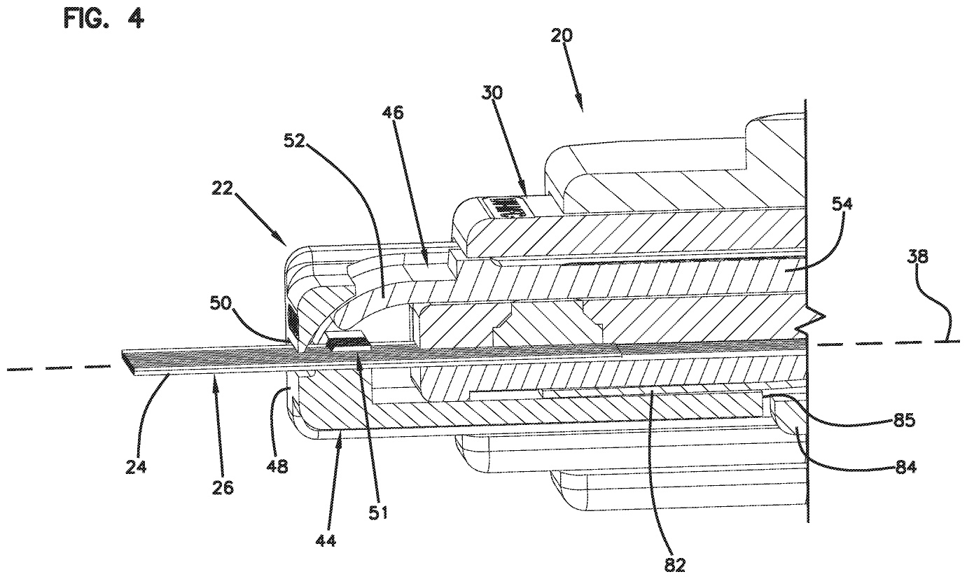

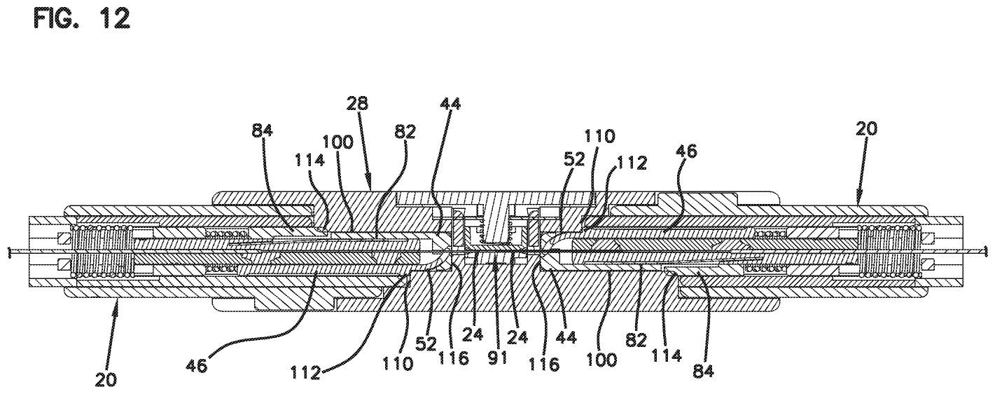

FIGS. 1-4 depict a fiber optic connector 20 in accordance with the principles of the present disclosure. The fiber optic connector 20 includes a front protection arrangement 22 movable between a fiber protection configuration (see FIGS. 1 and 3) and a fiber access configuration (see FIGS. 2 and 4). When the front protection arrangement 22 is in the fiber protection configuration, the front protection arrangement 22 is adapted for protecting front end portions 24 of optical fibers 26 of the fiber optic connector 20. When the fiber protection arrangement 22 is in the fiber access configuration, the front end portions 24 of the optical fibers 26 project forwardly beyond the front protection arrangement 22. The front end portions 24 are thus presented by the fiber optic connector 20 in such a way that the optical fibers 26 can be optically connected to the optical fibers of another fiber optic connector by a fiber optic adapter. FIG. 12 depicts an example fiber optic adapter 28 being used to optically connect the optical fibers 26 of two of the fiber optic connectors 20.

The fiber optic connector 20 includes a connector housing arrangement 30. When the front protection arrangement 22 is in the fiber protection configuration of FIGS. 1 and 3, the front end portions 24 of the optical fibers 26 are enclosed within the housing arrangement 30. In contrast, when the front protection arrangement 22 is in the fiber access configuration of FIGS. 2 and 4, the front end portions 24 of the optical fibers 26 extends forwardly beyond the connector housing arrangement 30.

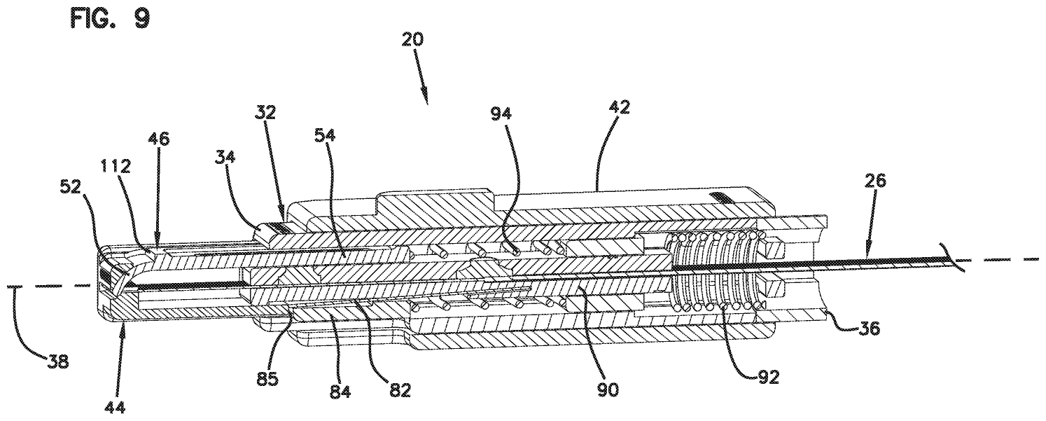

Referring to FIGS. 1 and 9, the connector housing arrangement 30 of the fiber optic connector 20 includes a connector body 32 having a front end 34 and a rear end 36. The connector body 32 can include one or more pieces or parts and can have a molded plastic construction. The connector body 32 defines a connector axis 38 that extends between the front and rear ends 34, 36. The optical fibers 26 are routed through an interior of the connector body 32 between the front and rear ends 34, 36.

The connector body 32 defines side catches 40 that are engaged by latches of a fiber optic adapter (e.g., the fiber optic adapter 28) when the fiber optic connector 20 is inserted within a port of the fiber optic adapter. The connector housing arrangement 30 further includes a release sleeve 42 that mounts over the connector body 32. The release sleeve 42 is slidable relative to the connector body 32 along the connector axis 38. The release sleeve 42 provides the function of disengaging the latches of the fiber optic adapter from the side catches 40 to allow the fiber optic connector 20 to be released from one of the ports of the fiber optic adapter. The release sleeve 42 also includes a key 44 for use in ensuring the fiber optic connector 20 is inserted into the port of the fiber optic adapter at the appropriate rotational orientation.

The connector housing arrangement 30 further includes the front protection arrangement 22. The front protection arrangement 22 includes a nose piece 44 and a shutter piece 46. The shutter piece 46 fits within the nose piece 44 and is slidable relative to the nose piece 44 in a forward-rearward orientation that extends along the connector axis 38. The shutter piece 46 and the nose piece 44 are both mounted at the front end 34 of the connector body 32 and are slidable relative to the connector body 32 along the connector axis 38. It will be appreciated that the interior of the connector body 32 can be configured for guiding sliding movement of the nose piece 44 and the shutter piece 46 relative to the connector body 32 along the connector axis 38.

As described above, the optical fibers 26 extend through the connector body 32 along the connector axis 38. The front end portions 24 of the optical fibers 26 are preferably non-ferrulized. By non-ferrulized, it is meant that the front end portions 24 are not bonded within a rigid ferrule for supporting the optical fibers. Preferably, the front end portions 24 each have a bare-fiber construction including only a fiber core surrounded by a fiber cladding. In other examples, coating layers may be provided over the cladding layers of the front end portions 24.

The nose piece 44 includes a front surface 48 through which a fiber opening 50 is defined. The fiber opening 50 is configured for receiving the end portions 24 of the optical fibers 26 when the fiber protection arrangement 22 is in the fiber access configuration of FIGS. 2 and 4. In the depicted example, the fiber opening 50 is configured to receive all of the optical fibers 26. In other examples, separate fiber openings can be provided for each of the optical fibers 26. In the depicted example, the optical fibers 26 include a row of optical fibers. In particular, twelve of the optical fibers 26 are shown in a row. In other examples, the optical fibers 26 may be configured in multiple rows. Additionally, aspects of the present disclosure are also applicable to fiber optic connectors having single optical fibers.

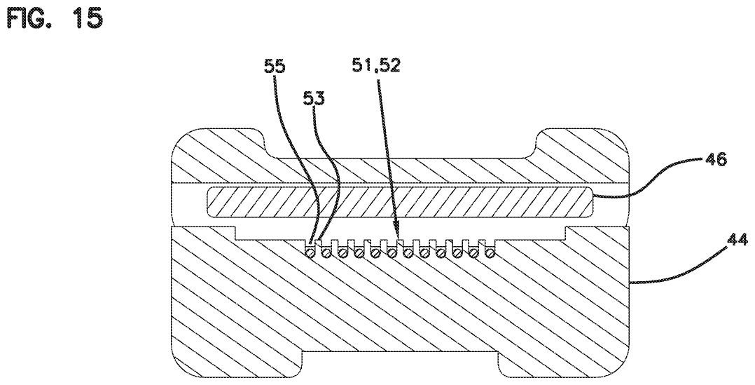

The nose piece 44 is movable along the connector axis 38 relative to the connector body 32 and the optical fibers 26 between a forward nose position (see FIGS. 1 and 3) and a rearward nose position (see FIGS. 2 and 4). The non-ferrulized front end portions 24 of the optical fibers 26 are recessed with respect to the front surface 48 of the nose piece 44 when the nose piece 44 is in the forward nose position. The optical fibers 26 extend through the fiber opening 50 with the non-ferrulized front end portions 24 of the optical fibers 26 projecting outwardly beyond the front surface 48 of the nose piece 44 when the nose piece 44 is in the rearward nose position. The nose piece 44 defines a fiber management structure 51 in the form of a comb 52 having a plurality of dividers 53 that defines channels 55 for receiving each of the optical fibers 26 (e.g., see FIG. 15).

Referring to FIG. 3, the shutter piece 46 includes a front shutter portion 52 and a rear portion 54. The rear portion 54 is elongate and linear in shape. The rear portion 54 interfaces with the interior of the connector body 32 and is linearly slidable relative to the connector body 32 along the connector axis 38. The connector body 32 and the rear portion 54 can have complimentary features that facilitate guiding sliding movement of the shutter piece 46 along the connector axis 38 within the connector body 32.

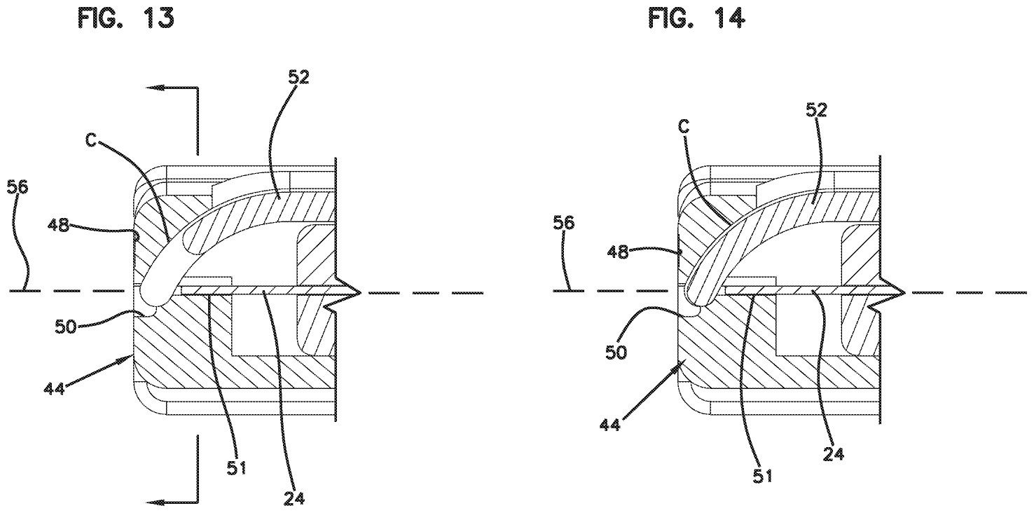

The front shutter portion 52 is adapted to flex relative to the rear portion 54 between a closed shutter position (see FIG. 3) in which the shutter portion 52 blocks the fiber opening 50 and an open shutter position (see FIG. 4) in which the shutter portion 52 does not interfere with the passage of the optical fibers 26 through the fiber opening 50. When the shutter piece 46 is in its forward position and the shutter piece 46 is also in the closed shutter position (as shown at FIG. 3), fiber axes 56 of the optical fibers 26 intersect the front shutter portion 52 (see FIG. 14). In contrast, when the front shutter portion 52 is in the open shutter position (as shown at FIG. 4), the front shutter portion 52 is offset from the fiber axes 56 (see FIG. 13).

In certain examples, the shutter piece 46 and the nose piece 44 can have a molded plastic construction. In a preferred example, the shutter piece 46 is molded with the front shutter portion 52 in the closed shutter position with respect to the rear portion 54 of the shutter piece 46. Molding the front shutter portion 52 with a curvature corresponding to the closed shutter positon facilitates installing the shutter piece 46 with respect to the nose piece 44.

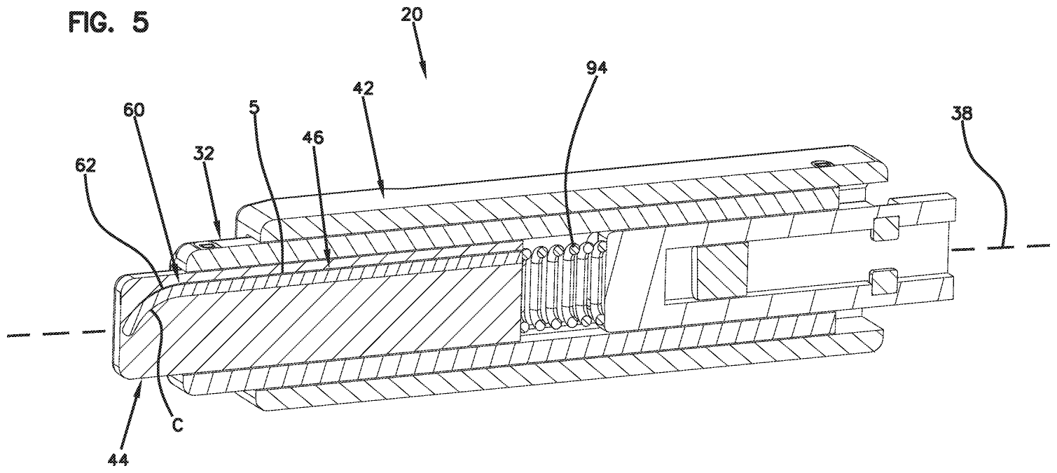

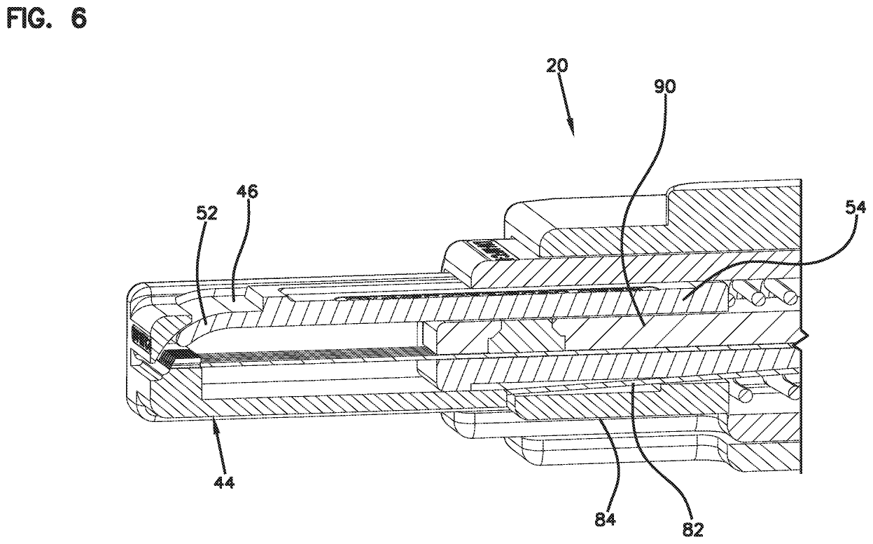

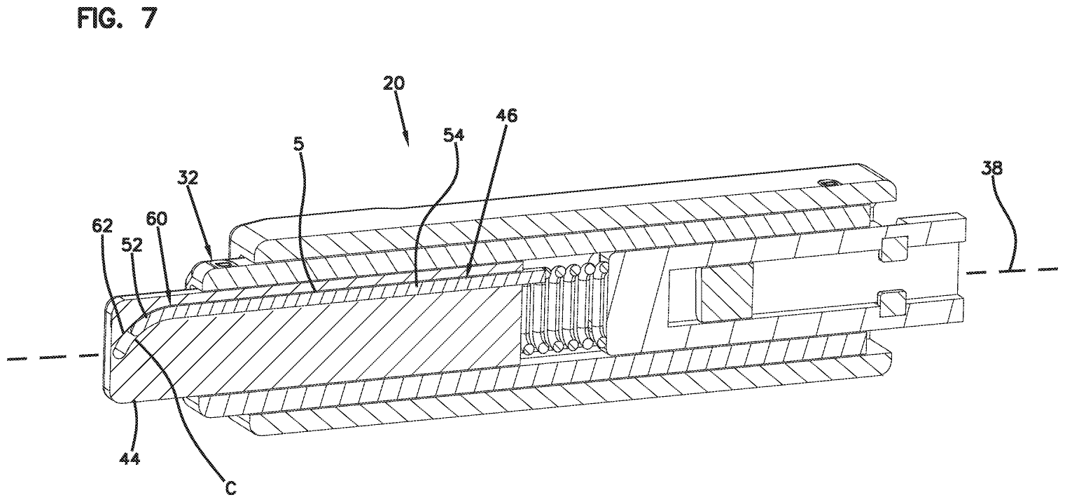

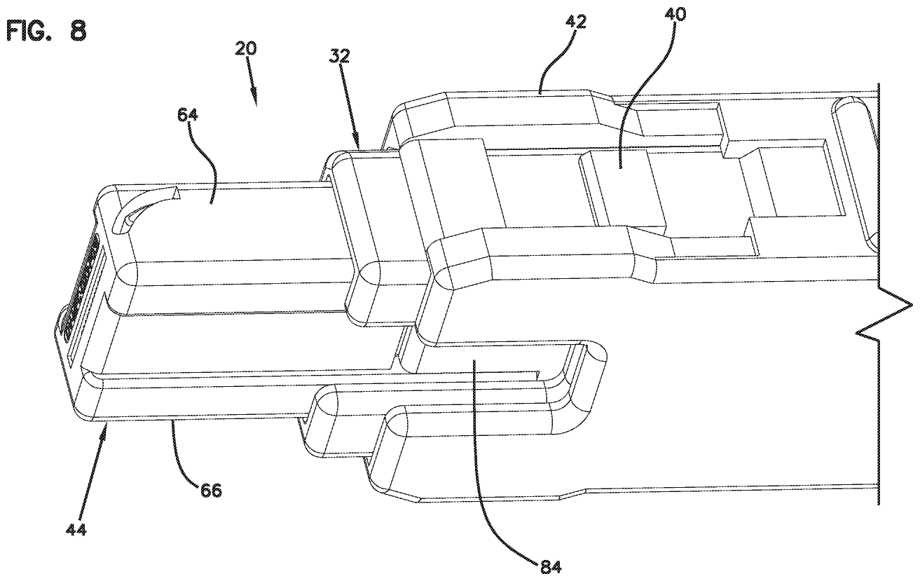

The fiber optic connector 20 further includes a mechanical interface 60 (see FIGS. 5 and 7) defined between the shutter piece 46 and the nose piece 44 for controlling flexion of the front shutter portion 52 of the shutter piece 46. The front shutter portion 52 is actuated between the closed and open shutter positions by generating relative movement between the nose piece 44 and the shutter piece 46 in an orientation along the connector axis 38. The mechanical interface 60 controls flexion of the front shutter portion 42 as the front shutter portion 52 moves from the closed shutter position to the open shutter position when the shutter piece 46 is moved rearwardly along the connector axis 38 relative to the nose piece 44. The mechanical interface 60 also controls flexion of the front shutter portion 52 as the front shutter portion 52 flexes from the open shutter position to the closed shutter position during forward movement of the shutter piece 46 relative to the nose piece 44 along the connector axis 38. The mechanical interface 60 positively controls flexation of the front shutter portion 52 as the front shutter portion 52 is closed and as the front shutter portion 52 is opened. Thus, the mechanical interface 60 ensures proper movement of the front shutter portion 52 between the open and closed positions. In certain examples, the front shutter portion 52 has a plastic construction that may plastically deform over time when remaining in a particular position over an extended time. Therefore, the mechanical interface 60 ensures that the front shutter portion 52 assumes the desired shape corresponding to the closed and open positions without reliance upon elastic characteristics of the material forming the front shutter portion 52. This allows the front shutter portion 52 to be manufactured of a plastic material as compared to more elastic material such as metal.

The mechanical interface 60 includes opposite guide channels 62 defined within the nose piece 44 adjacent left and right sides 64, 66 of the nose piece. Side channels 62 are located on opposite sides of the fiber management structure 51 for managing the optical fibers 26. The side channels 62 have a front curved section C having a curvature that correspond to a desired curvature of the front shutter portion 52 when the front shutter portion 52 is in the closed position. FIG. 5 shows the front shutter portion 52 in the closed position in which opposite sides (e.g., left and right sides) of the front shutter portion 52 are located within the front curved sections C of the side channels 62. As depicted at FIG. 5, the front shutter portion 52 is in the closed position and has a curvature that matches the curvature of the front curved sections C of the side channels 62. The side channels 62 also transition from the front curved sections C to rear straight sections S in which portions of the side portions of the front shutter portion 52 are located when the front shutter portion 52 is in the open position. The straight sections S guide linear sliding movement of the rear portion 54 of the shutter piece 46 relative to the nose piece 44. When the shutter piece 44 is moved linearly along the connector axis 38 relative to the nose piece 44, the side channels 62 force a curvature of the front shutter portion 52 to change as the shutter piece 46 is moved along the side channel 62. For example, as the shutter piece 46 is moved forwardly relative to the nose piece 44 along the side channels 62, the transition of the side channels 62 from straight to curved forces the front shutter portion 52 to assume the curved shape corresponding to the closed shutter position (see FIG. 5). In contrast, when the shutter piece 46 is moved rearwardly relative to the nose piece 44 along the side channels 62, the transition of the channels 62 from curved to straight forces at least a portion of the front shutter portion 52 to move from curved to straight (see FIG. 7). The shutter piece 46 can be molded with the front shutter portion 52 having a curvature that matches the curvature of the front curved sections C of the side channels 62, and with the rear portion being straight to match the rear straight sections S.

It will be appreciated that the opposite sides or edges of the front shutter portion 52 are minor sides, and that the front shutter portion 52 also includes major front and back sides 68, 70 that extend between the opposite minor sides.

In certain examples, the fiber optic connector 20 can include a nose piece locking arrangement 80 for retaining the nose piece 44 in the forward position of FIGS. 1 and 3. The nose piece locking arrangement 80 can include a locking member 82 that engages a retention surface 85 of the nose piece 44 to retain the nose piece 44 in the forward position. In a preferred example, the locking member 82 has a metal construction. In the depicted example, the locking member 82 is a metal leaf spring. Preferably, the locking member 82 is hidden within the connector housing arrangement 30 so as to be concealed from outside view. By concealing the locking member 82, the likelihood of tampering with the locking member 82 and/or accidentally or unintentionally moving the front protection arrangement 22 from the fiber protecting position to the fiber access position is reduced.

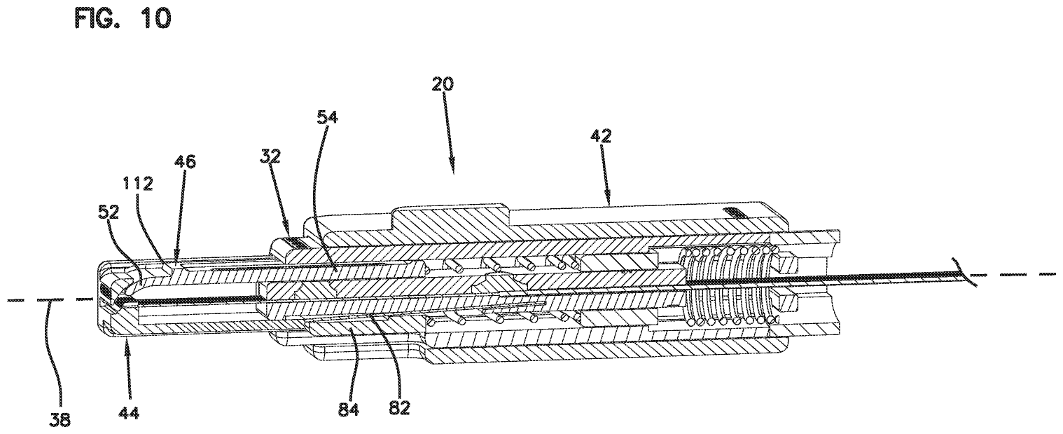

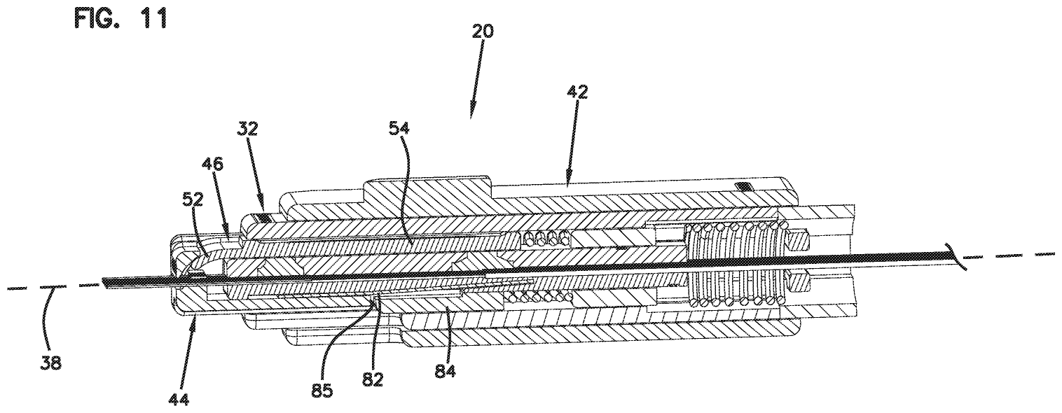

The locking member 82 is movable between a locking position (see FIGS. 9 and 10) in which the locking member retains the nose piece 44 in the forward nose position and a release position (see FIG. 11) in which the nose piece can move from the forward nose position to the rearward nose position. The locking member 82 can be biased toward the locking position by its own internal elastic structural characteristics. In certain examples, the locking member 82 is hidden from view by the nose piece 44. In certain examples, a cantilever portion 84 of the nose piece 44 aligns with and covers the locking member 82. The cantilever portion 84 can be flexed relative to the main body of the nose piece 44 to engage the locking member 82 and move the locking member from the locking position to the release position. It will be appreciated that the cantilever portion 84 can have a plastic construction and is part of the nose piece 44. Therefore, it is not readily apparent that the cantilever structure 84 is part of the locking arrangement 80.

In certain examples, the optical fibers 26 can be held within a fiber holder 90 mounted within the connector body 22. In certain examples, the optical fibers 26 can be bonded by an adhesive material within grooves defined by the fiber holder 90. In certain examples, a spring 92 can bias the fiber holder and thus the optical fibers 26 in a forward direction relative to the connector body 32. The fiber optic connector 20 can include a positive stop for limiting the distance the fiber holder can be moved forwardly relative to the connector body 32. In certain examples, the nose piece 44 and the shutter piece 46 can be spring biased in a forward direction relative to the connector body 32. In the depicted example, a single spring 94 is used to spring bias both the nose piece 44 and the shutter piece 46 forwardly relative to the connector body 32. In other examples, separate springs can be utilized.

It will be appreciated that the movement of the nose piece 44 and the shutter piece 46 is preferably sequenced as the front protection arrangement 22 is moved between the fiber protecting configuration and the fiber access configuration. To provide for such sequencing, the structure of the fiber optic connector 20 is preferably coordinated with corresponding structure provided within the fiber optic adapter 28. Specifically, when the fiber optic connector 20 is inserted within a port 100 of the fiber optic adapter 28, movement of the front protection arrangement 22 is sequenced such that the shutter piece 46 initially moves rearwardly relative to the nose piece 44 to cause the front shutter portion 52 to move from the closed shutter position of FIG. 9 to the open shutter position of FIG. 10. While the shutter piece 46 moves rearwardly relative to the nose piece 44, the nose piece 44 remains locked in its forward position by the locking member 82. Once the front shutter portion 52 has moved rearwardly from its forward most position (see FIG. 9) to an intermediate position (see FIG. 10) corresponding to the front shutter portion 52 being in the open shutter position, the locking member 82 is flexed from the locking position to the release position. Thereafter, the nose piece 44 and the shutter piece 46 are moved together in a rearward direction against the bias of the spring 94 until the nose piece 44 and the shutter piece 46 reach their rearmost position as shown at FIG. 11. With the nose piece 44 and the shutter piece 46 in their rearmost position, the front protection arrangement 22 is in the fiber access configuration and the front end portions 24 of the optical fibers 26 project forwardly from the front protection arrangement 22.

When the fiber optic connector 22 is removed from the port 100 of the fiber optic adapter 28, the sequence of movement between the nose piece 44 and the shutter piece 46 is reversed. For example, as the fiber optic connector 20 is withdrawn from the fiber optic adapter 28, the nose piece 44 and the shutter piece 46 are pushed from their rearmost positions forwardly by the spring 94. The nose piece 44 and the shutter piece 46 move forwardly together until the nose piece 44 reaches it forward most position and the locking member 82 elastically moves into the locking position. Thereafter, the nose piece 44 remains fixed in place and the shutter piece 46 continues moving forward via the biasing force provided by the spring 94. The continued forward movement of the shutter piece 46 causes the front shutter portion 52 of the shutter piece 46 to slide along the front curved portion C of the side channels 62 of the mechanical interface 60 thereby causing the front shutter portion 52 to flex from the curvature of open position to the curvature of the closed position.

It will be appreciated that the fiber optic adapter 28 includes structure coordinated with the structure of the fiber optic connector 20 for ensuring the sequenced movement of the nose piece 44 and the shutter piece 46 during insertion and removal of the fiber optic connector 20 from the port 100. For example, during insertion of the fiber optic connector 20 into the port 100, positive stop 110 within the fiber optic adapter 28 initially engages shoulder 112 of the shutter piece 46 causing the shutter piece 46 to move rearwardly relative to the nose piece 44 as the fiber optic connector 20 is inserted into the port 100. Once the fiber optic connector 20 is moved far enough into the port for the shutter piece 46 to reach the intermediate position of FIG. 10, cam 114 within the adapter port 110 engages the cantilever portion 84 of the nose piece 44 causing the cantilever portion 84 to flex into engagement with the locking member 82 such that the locking member 82 moves from the locking position to the release position. Continued movement of the fiber optic connector 20 into the port 100 brings the nose piece 44 into contact with positive stop 116. Contact between the positive stop 116 and the nose piece 44 as well as contact between the shutter piece 46 and the positive stop 110 causes the nose piece 44 and the shutter piece 46 to move together rearwardly relative to the connector body 32 as the fiber optic connector 20 is inserted further into the port 100. Insertion of the fiber optic connector 20 into the port 100 continues until the retention latches within the fiber optic adapter 28 engage the side catches 40 of the fiber optic connector 20.

The fiber optic connector 20 is removed from the port 100 by pulling back on the release sleeve 42 to disengage the adapter latches from the side catches 40. As the fiber connector 40 is withdrawn from the port 100, the spring 94 pushes the nose piece 44 and the shutter piece 46 forwardly until the nose piece 44 reaches its forward most position. The forward movement of the nose piece 44 and the shutter piece 46 is relative to the optical fibers 26 and the connector body 32. Thus, as the nose piece 44 and the shutter piece 46 are moved forwardly, the optical fibers 26 are retracted into the nose piece 44. When the nose piece 44 reaches its forward most position, the optical fibers 26 have been fully retracted into the interior of the connector housing arrangement 30 and are rearwardly offset from a path of the front shutter portion 52. With the nose piece 44 in its forward most position, the continued withdrawal of the fiber optic connector 20 from the port of the fiber optic adapter 28 allows the spring 94 to push the shutter piece 46 forwardly relative to the nose piece 44. As the shutter piece 46 is pushed forwardly relative to the nose piece 44, the mechanical interface 60 causes the front shutter portion 52 to flex relative to the rear portion 54 from the open shutter position to the closed shutter position.

It will be appreciated that as the connectors 20 are inserted into the ports 100 of the adapter 28, the front end portions 24 of the optical fibers 26 become exposed and are received within a fiber alignment system 91 (e.g., a bare fiber alignment system) of the fiber optic adapter 28 which co-axially aligns the optical fibers 22 of the fiber optic connectors 20 received in the ports 100 to provide optical connections therebetween.

The alignment systems can define alignment grooves for receiving and aligning the optical fibers. The alignment grooves can be defined by structures such as substrates which may each define one or more grooves. The substrates can include members such as plates which may have a ceramic construction, a metal construction, a plastic construction or other constructions. The alignment grooves can include grooves having v-shaped cross-sections (e.g., v-grooves) grooves having u-shaped cross-sections, grooves having trough-shaped cross-sections, grooves having half-circle shaped cross-sections or grooves having other shapes. In other examples, alignment grooves in accordance with the principles of the present disclosure can be defined by parallel cylindrical rods oriented in a side-by-side relationship. Various alignment structures defining grooves are disclosed by PCT International Publication Number WO 2018/020022, which is hereby incorporated by reference in its entirety. In certain examples, index matching gel can be used between opposing ends of optical fibers aligned within the alignment structures.

The various examples described above are provided by way of illustration only and should not be construed to limit the scope of the present disclosure. Those skilled in the art will readily recognize various modifications and changes that may be made with respect to the examples and applications illustrated and described herein without departing from the true spirit and scope of the present disclosure.

What is claimed is:

1. A fiber optic connector comprising:
a connector body having a front end and a rear end, the connector body defining a connector axis that extends between the front and rear ends;
an optical fiber routed through the connector body along the connector axis, the optical fiber having a non-ferrulized front end portion;
a shutter arrangement positioned at the front end of the connector body, the shutter arrangement including a nose piece and a shutter piece;
the nose piece including a front surface through which a fiber opening is defined, the nose piece being movable along the connector axis relative to the connector body and the optical fiber between a forward nose position and a rearward nose position, the non-ferrulized front end portion of the optical fiber being recessed with respect to a front surface of the nose piece when the nose piece is in the forward nose position, the optical fiber extending through the openings with the non-ferrulized front end of the optical fiber projecting forwardly beyond the front surface of the nose piece when the nose piece is the rearward nose position;
the shutter piece including a front shutter portion and an elongate rear portion, the front shutter portion being adapted to flex relative to the rear portion between a closed shutter position in which the front shutter portion blocks the fiber opening and an open shutter position in which the front shutter portion does not interfere with movement of the optical fiber through the fiber opening; and
a mechanical interface defined between the shutter piece and the nose piece for controlling flexion of the front shutter portion of the shutter piece, wherein the front shutter portion is actuated between the closed and open shutter positions by generating relative movement between the nose piece and the shutter piece in an orientation along the connector axis, wherein the mechanical interface controls flexion of the front shutter portion from the closed shutter position when the shutter piece is moved rearwardly along the connector axis relative to the nose piece, and wherein the mechanical interface controls flexion of the front shutter portion from the open shutter position to the closed shutter position when the shutter piece is moved forwardly relative to the nose piece along the connector axis.

2. The fiber optic connector of claim 1, wherein the elongate rear portion of the shutter piece slides within the connector body as the shutter piece moves along the connector axis, and wherein the connector body is configured to guide sliding movement of the shutter piece along the connector axis.

3. The fiber optic connector of claim 1, wherein a rear portion of the nose piece fits within the connector body and the connector body is configured to guide sliding movement of the nose piece along the connector axis.

4. The fiber optic connector of claim 1, further comprising a spring that biases the nose piece and the shutter piece in the forward direction.

5. The fiber optic connector of claim 1, wherein the front shutter portion straightens as the front shutter portion moves from the closed shutter position to the open shutter position, and wherein the front shutter portion curves as the front shutter portion moves from the open shutter position to the closed shutter position.

6. The fiber optic connector of claim 1, wherein the mechanical interface includes opposite guide channels defined by the nose piece that receive opposite sides of the shutter piece such that the opposite sides of the shutter piece are contained within the guide channels and slide along the guide channels when the shutter piece moves relative to the nose piece along the connector axis.

7. The fiber optic connector of claim 6, wherein the opposite sides are minor sides, and wherein the shutter piece has major front and back sides that extend between the opposite minor sides.

8. The fiber optic connector of claim 7, wherein at least portions of the guide channels are curved.

9. The fiber optic connector of claim 8, wherein the guide channels force a curvature of the shutter piece to change as the shutter piece is moved along the guide channels.

10. The fiber optic connector of claim 1, wherein the shutter piece is a molded plastic part.

11. The fiber optic connector of claim 10, wherein the shutter piece is molded with a curvature that matches a curvature of the channels.

12. The fiber optic connector of claim 1, wherein when the fiber optic connector is inserted into a fiber optic adapter, the shutter piece initially moves rearwardly relative to the nose piece such that the front shutter portion moves from the closed shutter position to the open shutter position before the nose piece moves rearwardly from the forward nose position, and once the front shutter piece is in the open position, the shutter piece and the nose piece move rearwardly together as the nose piece moves from the front nose position to the rear nose position.

13. The fiber optic connector of claim 12, wherein when the fiber optic connector is removed from the fiber optic adapter, the nose piece and the shutter piece initially move forwardly together until the nose piece reaches the forward nose position, and after the nose piece stops at the forward nose position, the shutter piece moves forwardly relative to the nose piece causing the front shutter portion to move from the open shutter position to the closed shutter position.

14. A shutter arrangement for a fiber optic connector, the shutter arrangement comprising:
a nose piece movable along a connector axis between a first nose position in which an end of an optical fiber of the fiber optic connector is protected within the nose piece and a second nose position in which the end of the optical fiber is presented for connection to an optical fiber of another fiber optic connector; and
a shutter that flexes between a first shutter position in which the shutter is intersected by an axis of the optical fiber and a second shutter position in which the shutter is not intersected by the axis of the optical fiber; and
a mechanical interface defined between the shutter and the nose piece for controlling flexion of the shutter, wherein the shutter is actuated between the first and second shutter positions by generating relative movement between the nose piece and the shutter in an orientation along the connector axis, wherein the mechanical interface controls flexion of the shutter from the first shutter position to the second shutter position when relative movement is generated between the nose piece and the shutter in a first direction along the connector axis, and wherein the mechanical interface controls flexion of the shutter from the second shutter position to the first shutter position when relative movement is generated between the nose piece and the shutter in a second direction along the connector axis, the second direction being opposite from the first direction.

15. The shutter arrangement of claim 14, wherein the shutter straightens as the shutter moves from the first shutter position to the second shutter position, and wherein the shutter curves as the shutter moves from the second shutter position to the first shutter position.

16. The shutter arrangement of claim 14, wherein the shutter moves in a rearward direction along the connector axis relative to the nose piece to cause the shutter to move from the first shutter position toward the second shutter position, and wherein the shutter moves in a forward direction along the connector axis relative to the nose piece to cause the shutter to move from the second shutter position toward the first shutter position.

17. The shutter arrangement of claim 14, wherein the mechanical interface includes opposite guide channels defined by the nose piece that receive opposite sides of the shutter such that the opposite sides of the shutter are contained within the guide channels and slide along the guide channels when the shutter moves relative to the nose piece along the connector axis.

18. The shutter arrangement of claim 17, wherein the opposite sides are minor sides, and wherein the shutter has major front and back sides that extend between the opposite minor sides.

19. The shutter arrangement of claim 18, wherein at least portions of the guide channels are curved.

20. The shutter arrangement of claim 19, wherein the guide channels force a curvature of the shutter to change as the shutter is moved along the guide channels.

21. The shutter arrangement of claim 14, wherein the shutter is a molded plastic part.

22. The shutter arrangement of claim 21, wherein the shutter is molded with a curvature that matches a curvature of the guide channels.

23. The shutter arrangement of claim 14, wherein the nose piece is spring biased toward the first nose position and the shutter is spring biased toward the first shutter position.

24. A fiber optic connector comprising:
a connector housing arrangement including a connector body and a nose piece;
the connector body having a front end and a rear end, the connector body defining a connector axis that extends between the front and rear ends;
an optical fiber routed through the connector body along the connector axis, the optical fiber having a non-ferrulized front end portion;
the nose piece including a front surface through which a fiber opening is defined, the nose piece being movable along the connector axis relative to the connector body and the optical fiber between a forward nose position and a rearward nose position, the non-ferrulized front end portion of the optical fiber being recessed with respect to a front surface of the nose piece when the nose piece is in the forward nose position, the optical fiber extending through the openings with the non-ferrulized front end of the optical fiber projecting forwardly beyond the front surface of the nose piece when the nose piece is in the rearward nose position; and
a nose piece lock including a locking member hidden within the connector housing arrangement for locking the nose piece in the forward nose position, the locking member being movable between a locking position in which the locking member retains the nose piece in the forward nose position and a release position in which the nose piece can move from the forward nose position to the rearward nose position.

25. The fiber optic connector of claim 24, wherein the nose piece includes a cantilever portion that conceals the locking member and that can be flexed to move the locking member from the locking position to the release position.

26. The fiber optic connector of claim 25, wherein the locking member is a metal leaf spring, and wherein the cantilever portion is plastic.
